(19) United States
(12) Patent Application Publication
(10) Pub. No.: US 2008/0124150 A1
(43) Pub. Date: May 29, 2008

(54) Fuser roller

(75) Inventor: Robert Schuman, Penfield, NY (US)

Correspondence Address: HISCOCK & BARCLAY, LLP, 2000 HSBC PLAZA, 100 Chestnut Street, ROCHESTER, NY, 14604-2404, US

(73) Assignee: Zinda Marketing, Inc. doing business as IMAGE PRODUCTS OF CALIFORNIA

(21) Appl. No.: 11/493,078

(22) Filed: Jul. 26, 2006

(51) Int. Cl. G03G 15/20

(52) U.S. Cl. 399/333

(57) ABSTRACT

The invention provides a fuser apparatus including a fuser roller and a pressing roller. The fuser roller includes one or more heat pipes situated in longitudinal bores in the roller body. The heat pipes are coated with a thermal interface material for conducting heat between the roller body and the heat pipe.

### FIELD OF THE INVENTION

This invention relates to fuser rollers for setting toner on paper in a photocopier, a laser printer, or another electrophotographic machine.

### BACKGROUND OF THE INVENTION

Photocopiers and laser printers use an electrophotographic process to impermanently apply loose toner powder to a sheet of paper. The toner must be subsequently melted to permanently fuse it with the fibers in the paper. The melting heat is generally applied by passing the paper between a pair of rollers wherein at least one of the rollers is heated by a heat source situated in an axial bore of the heated roller.

A common challenge with fuser rollers is to apply heat evenly to the sheet of paper. The distribution of heat is limited by the heat transfer properties of the fuser roller material. Heat pipes, which can rapidly transfer heat along the longitudinal direction, may be embedded in the roller to draw heat from hot portions of the roller to cooler portions in order to provide an even roller surface temperature. Embedding the heat pipes in the roller in a way that provides the maximum surface contact between the heat pipe and the roller is a further challenge. U.S. Pat. No. 5,300,996 issued to Yokoyama, et al. on Apr. 5, 1994 and U.S. Pat. No. 6,293,014 issued to Kitazawa, et al. both secure the heat pipe to the fuser roller by inserting the heat pipes into holes in the end of the roller and then heating the heat pipes. The working fluid in the heat pipes evaporates and expands and the outward pressure on the heat pipe plastically deforms the same, expanding its diameter. The plastic deformation secures the heat pipe in the fuser roller similarly to an interference fit and the surface of the heat pipe is in good contact with the fuser roller for efficient heat transfer.

The drawback of such an “expand-in-place” method of installing the heat pipes in the fuser roller include uncertainty in the uniformity of the deformation of the heat pipe. It is uncertain whether the heat pipe will expand sufficiently along the entire surface of the heat pipe to provide direct contact between the surface of the heat pipe and the fuser roller. Thus maximum heat transfer capability may not be realized between the heat pipe and the fuser roller. Further, the material properties (such as hardness) of the heat pipe are likely to change when deformed. Thus, the user must take care to expand the heat pipe in a way that results in the desired material properties. An even further drawback of the expand-in-place method is that it is carried out by placing the finished roller, including coatings, in an oven and heating the entire unit. The fuser roller is generally finished with coatings before inserting the heat pipes because the curing temperature for the coatings is typically above 700° F., which can damage or rupture the heat pipes. The additional heating of the finished roller exposes it to handling and heat damage. Also, the process adds to the manufacturing time and is costly.

Therefore what is desired is a fuser roller having embedded heat pipes with a simple method of installing the heat pipes that ensures an efficient heat transfer interface between the heat pipe and the fuser roller.

### SUMMARY OF THE INVENTION

The invention comprises, in one form thereof, a fuser apparatus including a fuser roller and a pressing roller. The fuser roller includes one or more heat pipes situated in longitudinal bores in the roller body. The heat pipes, the longitudinal bores, or both are coated with a thermal interface material such as a thermal grease or a thermal adhesive that provides a thermal interface for conducting heat between the roller body and the heat pipe.

More particularly, the invention includes a fuser roller for fixing toner to paper. The fuser roller comprises a roller body defining a longitudinal bore; a heat pipe having a longitudinal outer surface, the heat pipe being inserted into the bore; and a thermal interface material providing a heat conducting interface between the longitudinal outer surface and the bore. The thermal interface material may be a heat conducting adhesive or grease, such as a silicone grease. The fuser roller may include a plurality of longitudinal bores and a plurality of heat pipes inserted into the bores. The heat pipe is situated proximate to an outer surface of the roller body and the roller body further defines an axial bore and a heat source situated therein. The roller body may comprise a material such as aluminum, aluminum alloy, steel, or any other heat conducting material. The heat pipe comprises a sealed tube containing a working fluid and a wick or capillary structure. The tube may comprise a material such as copper, copper alloy, aluminum, aluminum alloy, steel, titanium, or other materials. The working fluid may comprise water, toluene, or another suitable substance.

In another form, the invention includes a method for producing a fuser roller. The method comprises the steps of providing a roller body defining at least one longitudinal bore; coating a longitudinal surface of a heat pipe or the longitudinal bore with a thermal interface material; and inserting the heat pipe into the bore such that the thermal interface material provides a heat conducting interface between the heat pipe and the roller body. In a particular embodiment, the thermal interface material coats substantially the entire longitudinal surface of the heat pipe. The roller body further defines an axial bore and the roller body is mounted with one or more heat sources disposed within the axial bore.

An advantage of the present invention is that the thermal interface material provides the heat conductive interface between the heat pipe and the roller body. Imperfections in the surface of the heat pipe, in the surface of the bore, or in the alignment of the heat pipe in the bore are compensated by the thermal interface material, which fills any gaps and provides a medium for efficiently conducting heat. A further advantage of the invention is that since the heat pipe is not deformed, it can be made to the desired specification. The user does not need to be concerned about changes in the hardness of the heat pipe, for example. Also, the costly and potentially damaging step of reheating the finished roller is avoided.

### BRIEF DESCRIPTION OF THE DRAWINGS

The present invention is disclosed with reference to the accompanying drawings, wherein:

FIG. 1 is an isometric view of the fusing apparatus of the present invention; and

FIG. 2 is a cross-sectional view of the fuser roller of FIG. 1.

Corresponding reference characters indicate corresponding parts throughout the several views. The examples set out herein illustrate several embodiments of the invention but should not be construed as limiting the scope of the invention in any manner.

### DETAILED DESCRIPTION

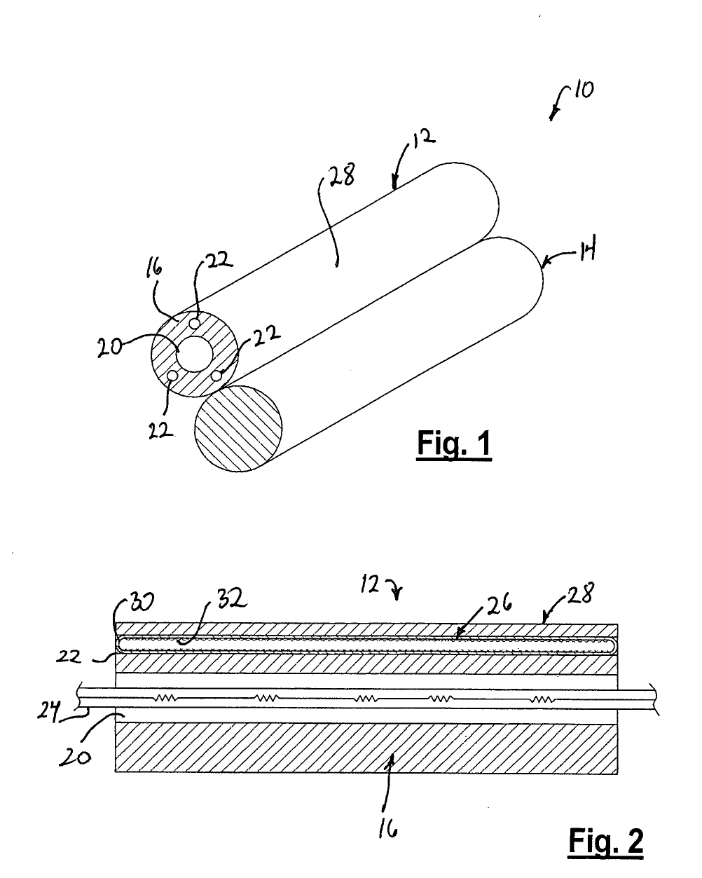

Referring to FIG. 1, there is shown the fusing apparatus of the present invention. The apparatus 10 includes a fuser roller 12 and a pressing roller 14. The fuser roller 12 and the pressing roller 14 are supported by bearings so that each roller may rotate about its central axis. A motor (not shown) rotates the fuser roller 12, the pressing roller 14, or both.

The fuser roller 12 includes a roller body 16, which is made from a thermally conductive material, such as aluminum or steel, and includes an axial bore 20 and a plurality of radially spaced longitudinal bores 22. The axial bore 20 and the longitudinal bores 22 are formed when extruding the roller body 16 or they are machined into the roller body 16 after it is extruded. As shown in FIG. 2, the axial bore 20 accommodates a heater 24, which comprises one or more lamps, such as halogen lamps.

The longitudinal bores 22 are each sized for a tight fit with a heat pipe 26, and the longitudinal bore 22, the heat pipe 26, or both are coated with a thermal interface material. The longitudinal bores 22 are shown as through holes; however, the bores 22 may be configured as blind bores such that the heat pipes 26 are inserted from one end only. The thermal interface material may be a heat conducting grease, a thermal adhesive that secures the heat pipe 26 to the inner surface of the axial bore 22, or another heat conducting material. The thermal interface material preferably has a high thermal conductivity, such as one that is 2.5 W/m·K (Watts per meter-Kelvin) or greater; however, lower thermal conductivities may be useful in certain applications. In a preferred embodiment, the thermal interface material has a thermal conductivity of 4.5 W/m·K. The thermal interface material should also have a high temperature resistance, such as for temperatures of over 400° F., as fuser rollers typically operate at temperatures between 350° F. to 400° F. and occasionally rising to 450° F. The thermal interface material preferably comprises a conductive matrix having a suspension media and a conductive filler. The suspension media may be, for example, silicone fluid, polysynthetic oil, acrylics, epoxy, or another suitable material. The conductive filler may be, for example, silver, silica, gold, copper, zinc oxide, aluminum oxide, thermally enhanced ceramic particles, other suitable substances, or combinations thereof.

The heat pipes 26 include a thermally conducting tube 30 with a working fluid sealed therein by crimping, welding, or both. Also located in the tube is a wick or capillary structure 32. The working fluid is chosen such that fluctuations in the temperature along the length of the heat pipe 26 will cause a phase change in the working fluid between a liquid and a gas. In a preferred embodiment of the fuser apparatus, the working fluid is water; however, alternative embodiments may utilize ammonia, acetone, methanol, toluene, or another suitable substance. The wick or capillary structure 32 provides a mechanism for returning condensed working fluid to the higher temperature portion of the heat pipe 26. In the present embodiment, the capillary structure 32 is a screen mesh. Other common wick and capillary structures used in heat pipes include a sintered metal powder, a number of longitudinal grooves in the inner surface of the tube providing a capillary structure, copper wires, and combinations of the different wick structures. The tube of the heat pipe 26 is copper or a copper alloy in a particular embodiment; however, aluminum, aluminum alloys, steel, or other thermally conducting materials may also be used.

The roller body 16 and heat pipes 26 are assembled by coating the heat pipes 26, the longitudinal bores 22, or both with the thermal interface material appropriate for conducting heat between the roller body 16 and the heat pipes 26. Each of the heat pipes 26 is inserted into a longitudinal bore 22.

In use, the roller body 16 rotates about the heater 24 and the heater 24 transfers heat to the inner surface of the axial bore 20. The heat is conducted through the roller body 16 to the outer surface 28 of the fuser roller 12. Fluctuations in the temperature along the length of the fuser roller 12 are corrected by the heat pipes 26. A high temperature region in the fuser roller 12 will cause the working fluid in the portion of the heat pipe(s) 26 proximate to the high temperature region to evaporate, absorbing energy from the high temperature region in the form of the heat of vaporization. The gas in the tube redistributes to even out the vapor pressure and the gas moves to cooler portions of the heat pipe 26. The gas condenses in the cooler region and transfers the latent heat to the roller body 16. The condensed working fluid is redistributed by the wick or capillary structure so that the high temperature area may evaporate the working fluid until the temperature equalizes or a different region becomes a high temperature region. Thus, the vaporization/condensation of the working fluid rapidly transfers heat between regions of the fuser roller 12 to provide an even surface temperature on the surface 28.

The heat applied by the heater 24 may be controlled by monitoring the surface temperature of the surface 28 with a thermistor or other temperature sensing device. A piece of paper with recently-applied toner particles is passed to the fuser assembly 10 and passes between the fuser roller 12 and the pressing roller 14. The heat of the surface 28 of the fuser roller 12 melts the toner and fuses it with the fibers of the paper.

In an alternative embodiment, the pressing roller 14 is replaced by a second heated fuser roller with heat pipes. In a further alternative embodiment, the fuser roller 12 is externally heated such as by an infrared source, a mating heated roller, other suitable heating means, or combinations thereof.

It should be particularly noted that although three heat pipes are shown in the figures, any number may be used as controlled by cost and the sensitivity of the application to changes in temperature along the length of the fuser roller 12. It should also be noted that the pressure roller 14 may also be heated, which is especially useful in high page per minute applications. Such a heated pressure roller may also include heat pipes for providing an even distribution of the heat in the roller. In a particular embodiment, a thermal interface material is included between the heat pipes and the heated pressure roller.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A fuser roller for fixing toner to paper, the fuser roller, comprising:
a roller body defining at least one longitudinal bore;
a heat pipe having a longitudinal outer surface, the heat pipe being inserted into the longitudinal bore; and
a thermal interface material providing a heat conducting interface between the longitudinal outer surface and the bore.

2. The fuser roller of claim 1, the thermal interface material being selected from the group consisting essentially of heat conducting grease and heat conducting adhesive.

3. The fuser roller of claim 1, further comprising a plurality of longitudinal bores and a plurality of heat pipes inserted into the bores.

4. The fuser roller of claim 1, the heat pipe being situated proximate to an outer surface of the roller body.

5. The fuser roller of claim 1, the roller body further defining an axial bore and a heat source situated therein.

6. The fuser roller of claim 1, the roller body comprising a material selected from the group consisting essentially of aluminum, aluminum alloy, and steel.

7. The fuser roller of claim 1, the heat pipe comprising a sealed tube containing a working fluid.

8. The fuser roller of claim 7, the heat pipe further comprising a wick or capillary structure.

9. The fuser roller of claim 7, the sealed tube of the heat pipe comprising a material selected from the group consisting essentially of copper, copper alloy, aluminum, aluminum alloy, and steel.

10. The fuser roller of claim 7, the working fluid comprising water.

11. The fuser roller of claim 1, wherein the roller body is proximate to a pressure roller.

12. The fuser roller of claim 11, the pressure roller being heated.

13. The fuser roller of claim 1, the roller body being heated by an external heat source.

14. The fuser roller of claim 1, the thermal interface material having a thermal conductivity of about 2.5 W/m·K or greater.

15. A method for producing a fuser roller, comprising the steps of:
a) providing a roller body defining at least one longitudinal bore having an inner surface;
b) coating a longitudinal surface of a heat pipe or the inner surface of the longitudinal bore with a thermal interface material; and
c) inserting the heat pipe into the longitudinal bore such that the thermal interface material provides a heat conducting interface between the heat pipe and the roller body.

16. The method of claim 15, wherein the thermal interface material coats substantially the entire longitudinal surface of the heat pipe or the inner surface of the longitudinal bore.

17. The method of claim 15, wherein the roller body further defines an axial bore.

18. The method of claim 17, further comprising the step of mounting the roller body with one or more heat sources disposed within the axial bore.

19. The fuser roller of claim 15, the thermal interface material being selected from the group consisting essentially of heat conducting grease and heat conducting adhesive.

20. The fuser roller of claim 15, the thermal interface material being applied to both the inner surface of the longitudinal bore and the longitudinal surface of the heat pipe.
